(19) United States
(12) Patent Application Publication
(10) Pub. No.: US 2012/0287652 A1
(43) Pub. Date: Nov. 15, 2012

(54) LIGHTING DEVICE

(75) Inventors: Nicole Breidenassel, Bad Abbach (DE); Guenter Hoetzl, Regensburg (DE); Fabian Reingruber, Muenchen (DE); Simon Schwalenberg, Donaustauf (DE)

(73) Assignee: OSRAM AG, Muenchen (DE)

(21) Appl. No.: 13/522,510

(22) PCT Filed: Apr. 14, 2011
(86) PCT No.: PCT/EP2011/050444

§ 371 Date: Jul. 17, 2012

(30) Foreign Application Priority Data
Jan. 20, 2010 (DE) 10 2010 001 046.4

(51) Int. Cl. F21V 29/00

(52) U.S. Cl. 362/373

(57) ABSTRACT

A lighting device may include at least one partially light-transmissive cover which covers at least one light source, so that a hollow chamber is provided between the at least one light source and the cover, and at least one heat sink structure, which is at least one of at least partially arranged in the hollow chamber and is set at least partially into the cover.

The invention relates to a lighting device, in particular an LED lighting device, in particular an LED retrofit lamp.

In general, light-emitting diodes have lower brightnesses and shorter service lives at higher temperatures. An LED lamp typically has a cap, a heat sink, an LED module and a transparent or semi-transparent lamp bulb or a transparent or semi-transparent cover pane. In LED retrofit lamps, a heat sink is typically used for heat removal. However, the space available for the heat sink is restricted, particularly for standard-conform lamps, inter alia by the space required for a bulb and the driver electronics. Thus, the size of the volume usable for cooling, and consequently the cooling effectiveness, are limited.

It is an object of the present invention at least partially to prevent the stated disadvantages and, in particular, to provide a possibility for improved cooling, including for standard-conform lighting devices.

This object is achieved with the features of the independent claims. Preferred embodiments are disclosed, in particular, in the dependent claims.

The object is achieved with a lighting device including at least one partially light-transmissive cover which covers at least one light source, in particular a light-emitting diode, so that a hollow chamber is provided between the at least one light source and the cover, and including at least one heat sink structure which is at least partially arranged in the hollow chamber and/or is set at least partially into the cover.

The heat sink can be further cooled via said heat sink structure(s) into the region of the cover and can thereby cool better without the size and optical function of the lighting device needing to be changed. Thus, larger heat loss values can be conducted away for better cooling while conforming to the lamp standards.

The heat sink structure can be arranged, in particular, at least partially and therefore also completely in front of the at least one light source. The designations ‘in front of’/‘front’ and ‘behind’/‘rear’ relates to the main radiating direction or optical axis of the light source. In front of a light source therefore means positioned in the hemisphere in front of the at least one light source (‘front hemisphere’) centered on the main radiating direction. For example, a light-emitting diode can radiate as a Lambertian source into the front hemisphere without further measures, but not into the complementary ‘rear hemisphere’.

The lighting device can also include a heat sink base having a mounting surface for the at least one light source and conventional heat sink structures arranged rearwardly and/or directed laterally outwardly in relation to the at least one light source. Said heat sink base can approximately correspond to a conventional heat sink. The light source can be mounted or fastened directly at the heat sink base, for example, by means of an adhesive paste or an adhesive film or mounted indirectly at the heat sink base, for example, via a carrier substrate such as a submount and/or a circuit board.

In one embodiment, the at least one heat sink structure is connected to the heat sink base. By this means, particularly effective heat conduction into the at least one heat sink structure can be achieved.

In another embodiment, the at least one heat sink structure is connected to the mounting surface of the heat sink base for the at least one light source. The resulting good thermal connection of the heat sink structure to the relatively warm mounting surface on which the at least one light source is directly or indirectly mounted enables a large heat flow into the heat sink structure (e.g. ‘internal’ heat sink fins or heat sink struts), with the result that improved cooling is produced. A compact structure is also facilitated.

The at least one heat sink structure and the heat sink base, which together constitute the (overall) heat sink, can be configured in one part or multiple parts. The at least one heat sink structure can be, for example, a separately manufactured heat sink part which is glued or pushed onto the heat sink base, particularly on the mounting surface thereof. For optimized thermal connection and mechanical stability, the at least one heat sink structure can be manufactured in one piece with the heat sink base, for example, from a single casting.

The type of the at least one light source is essentially unrestricted. The least one light source can, in particular, include a semiconductor light source, for example a laser diode and/or a light-emitting diode.

The light-transmissive material of the cover may include a transparent or translucent (e.g. milky white) material. The cover can be made with, in particular from, plastics, glass or ceramic material.

The plastic can, in particular, be a thermally conductive and sufficiently temperature-stable light-transmissive plastic, for example, polycarbonate. A configuration that is optimized for improved thermal conductivity is that the light-transmissive material has a plastic material filled with highly thermally conductive particles. Alternatively, the cover may include glass, in particular, a thermally conductive glass having a thermal conductivity of more than 1.1 W/(m·K), for example, Borofloat with a conductivity of 1.2 W/(m·K). Alternatively, a transparent ceramic material (e.g. a transparent aluminum oxide ceramic) can be used as the light-transmissive material, which can have much greater thermal conductivity. Due to the increased thermal conductivity of the cover, heat can readily be passed through said cover to the ambient air.

For an effective thermal conduction, the heat sink structure is made from a thermally highly conductive material (thermal conductivity >15 W/(m·K), in particular from a metal or a metal alloy, particularly including copper and/or aluminum. By this means, the material of the heat sink structure can effectively conduct away the heat of the light source(s) into the front, cooler region of the cover and/or of the hollow chamber, with the result that better cooling is achieved.

In another embodiment, the cover is a bulb and the hollow chamber is a bulb (interior) chamber. This configuration is advantageous, in particular, for realizing an incandescent lamp-type retrofit LED lamp. The bulb can have, in particular, a spherical cupola form. The bulb can then be fastened, in particular, with the edge thereof on the mounting surface of the heat sink base.

Alternatively, the cover can be a disk-shaped cover for a funnel-shaped hollow chamber. The at least one light source can be arranged at the base of the funnel. A cover of this type is advantageous, in particular, for realizing a halogen reflector lamp-type retrofit LED lamp.

The cover, aside from the protective function thereof, can also have an optical function. For this purpose, one or more optical regions, for example lens-type regions, can be integrated into the cover, at least partially. In other words, the cover can also be used for specific beam control in the manner of a lens.

In another embodiment, the heat sink structure is arranged at least partially within the hollow chamber, thus supporting thermal coupling to the hollow chamber. The heat sink structure can be arranged, in particular, completely within the hollow chamber, thus facilitating manufacturing of the cover.

In another embodiment, the heat sink is spaced apart from the cover, at least partially. In an embodiment of this type, the heat sink structure and the cover-side surfaces of the heat sink structure that are relevant for cooling are preferably arranged close to the (inner) wall of the cover, particularly at a distance of not more than 10 mm, more particularly not more than 3 mm, even more particularly less than 1 mm, from the cover. Due to the position of the heat sink structure(s) close to the wall, the heat is better removed from the heat sink structure to the relevant cover regions and then released therefrom to the surroundings.

Alternatively or additionally, the heat sink structure can lie against the cover.

In another embodiment, the heat sink structure is at least partially surrounded by a light-transmissive material of the cover, in particular cast therewith. The use of plastic has the advantage, inter alia, that the heat sink can be cast in a particularly simple manner with the cover, in particular cast therein.

The heat sink can at least partially project into the hollow chamber and/or can be at least partially surrounded by the light-transmissive material of the cover. This results in a very good thermal connection and mechanical stability.

The heat sink structure can, in particular, be completely surrounded by the light-transmissive material and, in particular, cast therein. This can simplify manufacturing.

The heat sink structure may include at least one wire and/or thread. For effective heat removal, a plurality of wires and/or threads can be used. Said wires/threads have, inter alia, the advantage of easy and economical processing ability.

In another embodiment, the heat sink structure projects at least as far as a center or mid-height of the hollow chamber, in particular at least as far as an upper quarter of the hollow chamber, in particular as far as an upper tip of the hollow chamber.

In other words, the heat sink structure can project far enough forwardly or upwardly that in respect of a maximum height hmax of the hollow chamber as from the at least one light source said heat sink structure has a height of at least hmax/2, in particular at least hmax·¾, in particular hmax. The fact that the heat sink structure reaches as far as an upper tip of the hollow chamber means that said heat sink structure extends over at least the entire height of the hollow chamber. If the heat sink structure also extends through the covering or is part thereof, said heat sink structure also extends, in particular, at least over the whole height of the cover, i.e. as far as the outer tip thereof.

Due to the heat sink structure(s) projecting into the front region of the hollow chamber, said heat sink structures are surrounded by cooler air, since the hollow chamber is cooler in the front region thereof than in the lower or rear region thereof close to the heat sink mounting surface and the light source(s). Consequently, the further forward the heat sink structure reaches and the more of the surface thereof that lies in the front part of the cover and/or of the hollow chamber, the better said heat sink structure is cooled. A larger cooling surface in the front region of the cover and/or of the hollow chamber is also optically advantageous, for example, for LED retrofit lamps, since light-emitting diodes have a stronger forward radiation than incandescent lamps, so that weaker lateral and stronger forward shading is able to approximate more closely the radiating characteristics of the LED lamp to the radiating characteristics of the incandescent lamp.

In another embodiment, the heat conduction in the heat sink structure in the front region of the cover and/or of the hollow chamber occurs essentially along an inner side of the cover. By this means, heat removal takes place on the route to the front region of the cover through the cover into the surroundings.

In another embodiment, the heat sink structure replaces part of the cover (i.e. of the light-transmissive material), in particular a front part of the cover and/or of the hollow chamber. In this embodiment, the heat sink structure can therefore be present, at least partially, in place of the light-transmissive material of the cover. In this way, in particular, part of the heat sink structure can have an outwardly exposed surface. The replacement of, for example, the front part of the cover by the outwardly exposed part of the heat sink structure enables particularly effective cooling by means of the direct contact of the heat sink surface with the ambient air.

In another embodiment, the heat sink has heat sink structures, in particular cooling struts, arranged with rotational symmetry. In this way, the heat radiated by the light-emitting diodes can be distributed over a large area, increasing the cooling capacity. The cooling struts can be, in particular, uncovered.

In general, the heat sink structures can be arranged, from a thermal standpoint, in the region of the hollow chamber such that said structures are spaced as far apart from one another as possible and therefore distribute the heat over a large area. Rotationally symmetrically arranged, particularly internal, elements of the heat sink structure, for example, fins or struts are arranged far apart from one another, so that the mutual thermal influence thereof is minimized and said elements are arranged in a relatively cool environment and are therefore better able to cool.

In a thermally optimized variant, for example, any cooling structures (cooling struts/ribs/surfaces, etc.) can be arranged with rotational symmetry round the LEDs mounted on the heat sink base. Since the cooling power also depends on the size of the cooling strut surface facing the cover, given a rotationally symmetrical arrangement, a relatively small number of thicker cooling struts and a relatively large number of thinner cooling struts can lead to an approximately similar cooling power. Thinner cooling struts can be configured, inter alia, as wires or threads.

In a development, the cooling struts at least partially have a cross-sectional form which widens toward the cover, particularly the bulb. In this way, a surface directed toward the cover can be kept large for a large heat transfer to the cover, while at the same time optical shading can be kept low.

In another embodiment, the heat sink structure, particularly the cooling struts, at least partially have a cross-sectional form which widens toward the cover, particularly the bulb. A cross-section of the cooling struts which, for example, narrows toward the interior and widens toward the exterior can be sufficiently large, firstly, to enable a good throughput of heat into the front region of the cover and/or of the hollow chamber and, secondly, to permit as large a surface of the individual cooling struts (or another heat sink structure) as possible to adjoin the cover, thereby increasing the cooling power. Broadening the heat sink, in particular cooling struts, in the front part of the cover and/or of the hollow chamber therefore creates a particularly effective cooling surface. From the optical standpoint, such a cross-section of the cooling struts which narrows toward the interior and widens toward the exterior is equally favorable, since therewith the shading of the light radiated by the LEDs can be reduced by the internal heat sink structure.

A cross-sectional form of the heat sink structure is generally a thermal-optical compromise. The cross-sectional form should be chosen from the thermal standpoint so that the heat sink is sufficiently large in order, firstly, to conduct the heat efficiently into the hollow chamber or region of the cover and, secondly, to result in the largest possible surface area adjoining the cover. This can apply, for example, for individual, or all, cooling struts. A further suitable cross-sectional variant for a compact LED light source arranged in the center can be, for example, a conical cross-section narrowing toward a center, with a round outer edge adapted to the shape of the cover.

In another embodiment, a largest part of the surface (>50%) of the heat sink structure is arranged at a front half of the cover and/or of the hollow chamber. This increases the heat removal. The front half should be understood to mean the half which, starting from the at least one light source, is furthest removed forwardly.

In a thermally optimized embodiment, the heat sink structure has the largest possible surface area in or at the front region of the cover and/or of the hollow chamber and, in particular, preferably more than 5%, more preferably more than 20%, most preferably more than 50% of the heat sink surface, in particular of a heat sink surface of a heat sink structure arranged in the hollow chamber facing toward the cover can be arranged in the front half of the hollow chamber. In the case of the heat sink structure arranged in the hollow chamber, in general a contact with the cover which is particularly relevant for cooling takes place in the front region of the cover and/or of the hollow chamber.

In another embodiment, the heat sink structure narrows in a forward region of the cover and/or of the hollow chamber, in particular at the tip thereof. This embodiment can, in particular, be used with a mirrored or diffusely scattering cover. A narrowing of the heat sink structure, in particular the cooling struts, in the front part of the cover produces a still more effective cooling surface. Furthermore, an embodiment which is advantageous from the stability and manufacturing standpoints results therefrom.

In another embodiment, at least part of the heat sink structure includes an optically active, particularly specular (mirrored) or diffusely reflecting (scattering), surface. By this means, beam control and light radiating characteristics can be influenced in a specific manner. The optically active surface may include, for example, roughening, a coating and/or a paint covering. By this means, beam control and/or spatial homogenizing of the light emitted from the lighting device can be implemented.

In another embodiment, the heat sink structure has a position and/or form matched to the heat sink structure. In an optically adapted variant, heat sink struts lying further outwardly can lead to lower light losses, whereas heat sink struts lying further inwardly lead to greater homogeneity of the light radiation.

In another embodiment, the heat sink structure has a (centered) central column which projects forwardly from the mounting region as far as the cover. By means of the central column, the heat can be conducted over a large area from the heat sink base, in particular the mounting surface, into the central column and through the central column into the front region of the cover, thus promoting particularly effective cooling.

In another embodiment, the central column extends in a forward region at least partially laterally further than a group of at least two light sources surrounding the central column. The light sources can be arranged, for example, in an annular shape round the central column, for example with a central cut-out for the central column. This results in the advantages that no, or no substantial, optical frontal shading is caused by the central column and production and/or assembly of the heat sink structure with the heat sink base are simplified.

In addition, the central column can be used as a reflector and/or diffuser in order to amplify the lateral radiation of light.

In another embodiment, the lighting device is a retrofit lamp, in particular an incandescent lamp-type retrofit lamp. In an embodiment of this type, the invention can be implemented particularly favorably, since the retrofit lamps are standard-conform lamps.

The lighting device can generally be a lamp, a luminaire, a lighting system and/or a part thereof.

The invention will now be described schematically in greater detail making reference to exemplary embodiments illustrated in the drawings. For convenience, similar or similarly acting elements are identified with the same reference characters.

In the drawings:

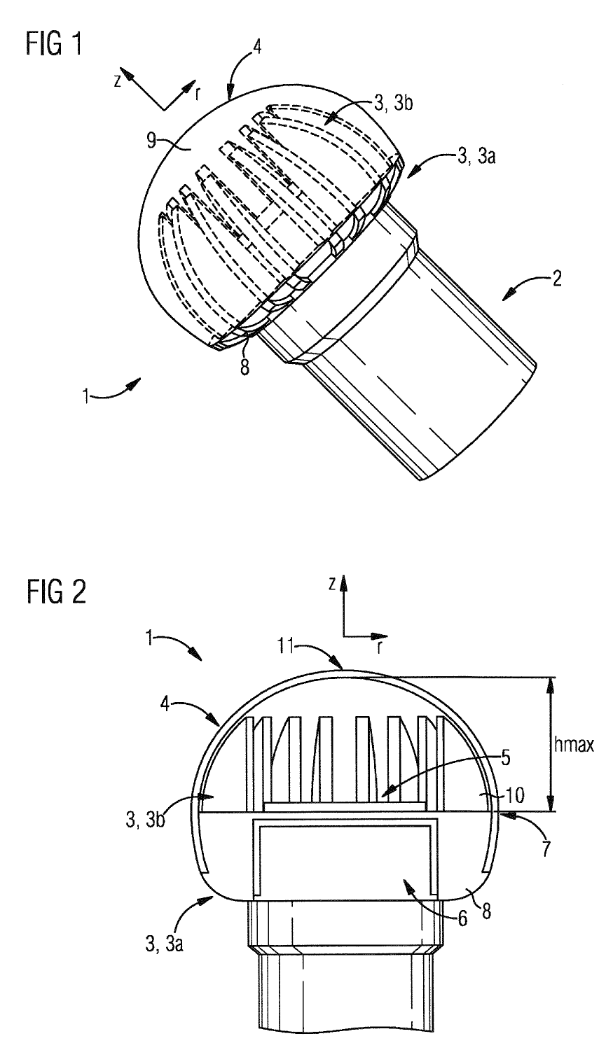

FIG. 1 shows a side view of an LED retrofit lamp according to the invention in a first embodiment;

FIG. 2 shows a sectional representation of a side view of the LED retrofit lamp according to the first embodiment;

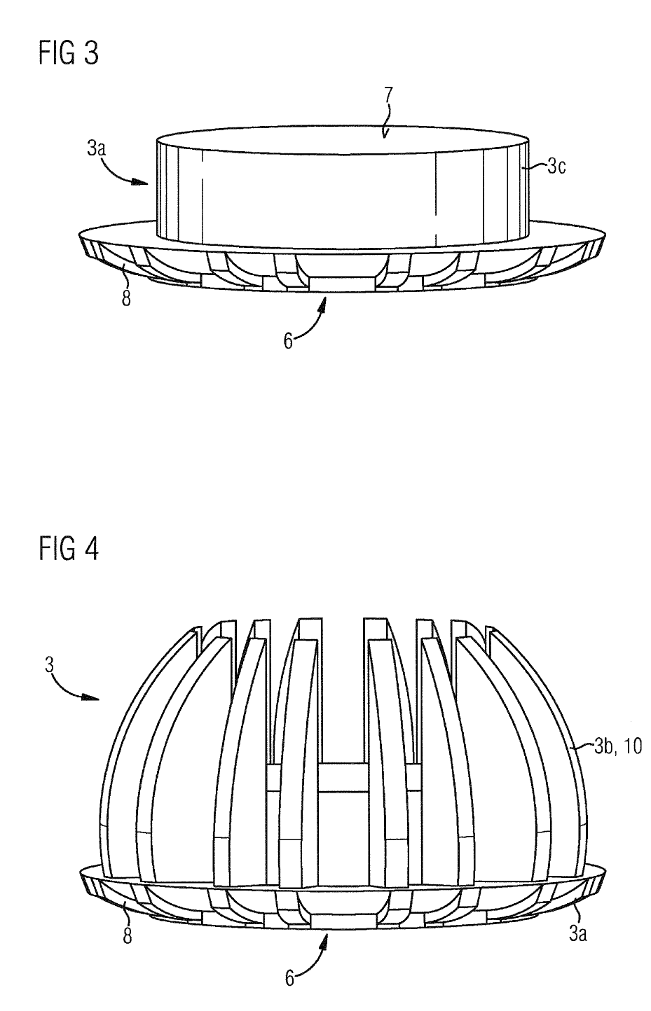

FIG. 3 shows a side view of a first part of a two-part heat sink of the LED retrofit lamp according to the first embodiment;

FIG. 4 shows a side view of the overall heat sink of the LED retrofit lamp according to the first embodiment;

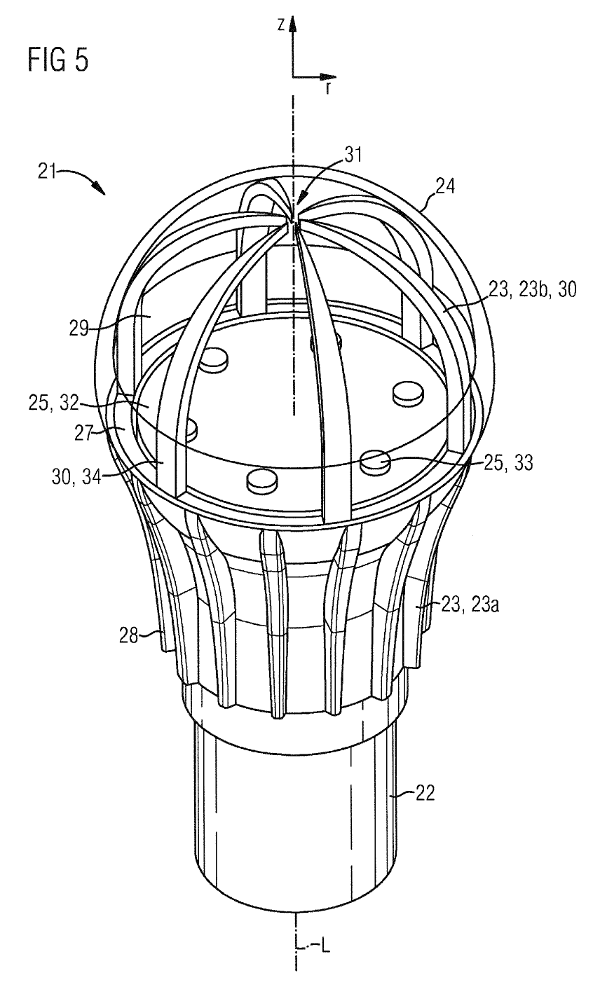

FIG. 5 shows a view from obliquely above of an inventive LED retrofit lamp according to a second embodiment;

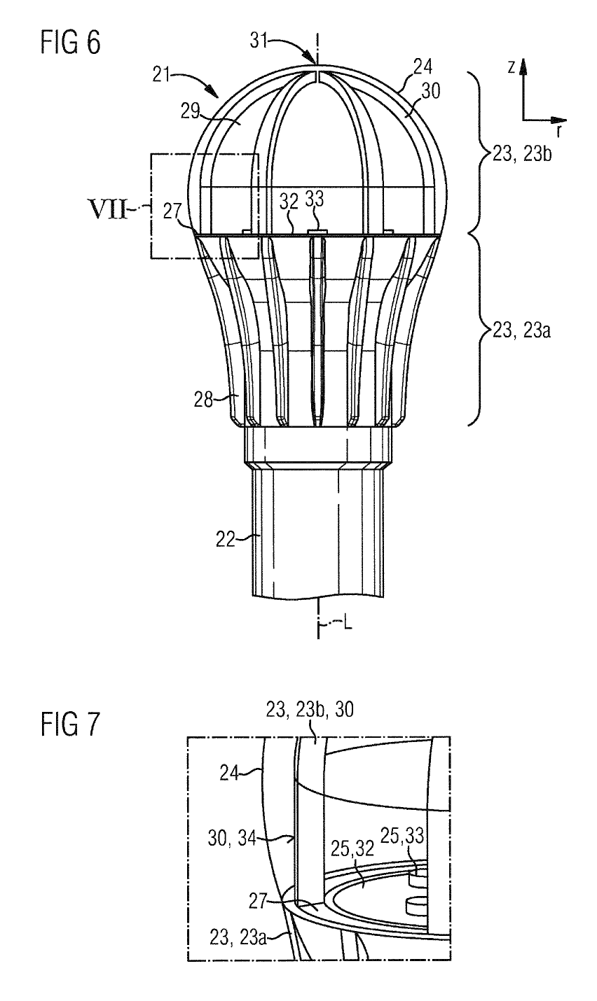

FIG. 6 shows a side view of the LED retrofit lamp according to the second embodiment;

FIG. 7 shows an enlarged section of FIG. 6;

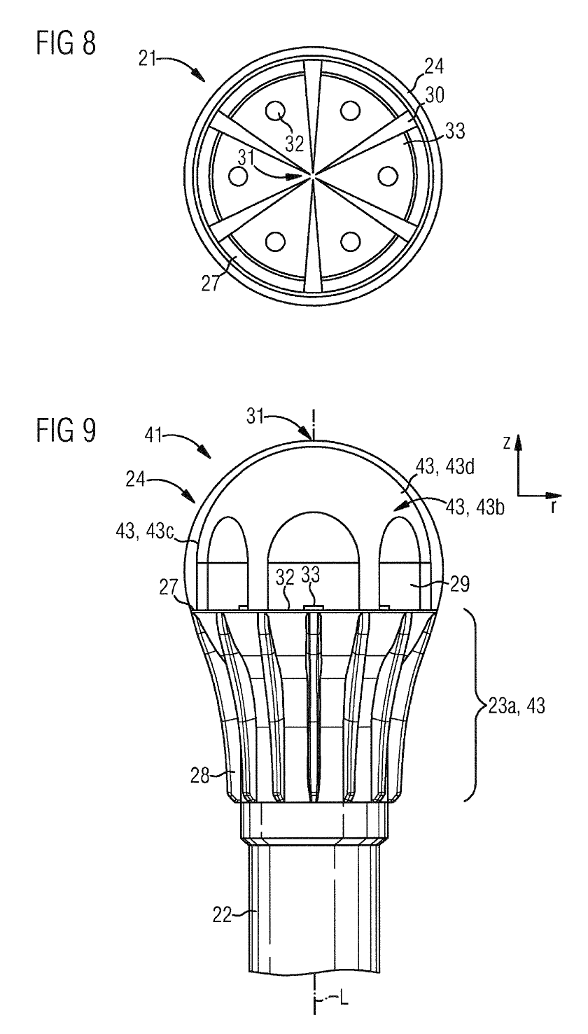

FIG. 8 shows a plan view of the LED retrofit lamp according to the second embodiment;

FIG. 9 shows a side view of an LED retrofit lamp according to a third embodiment;

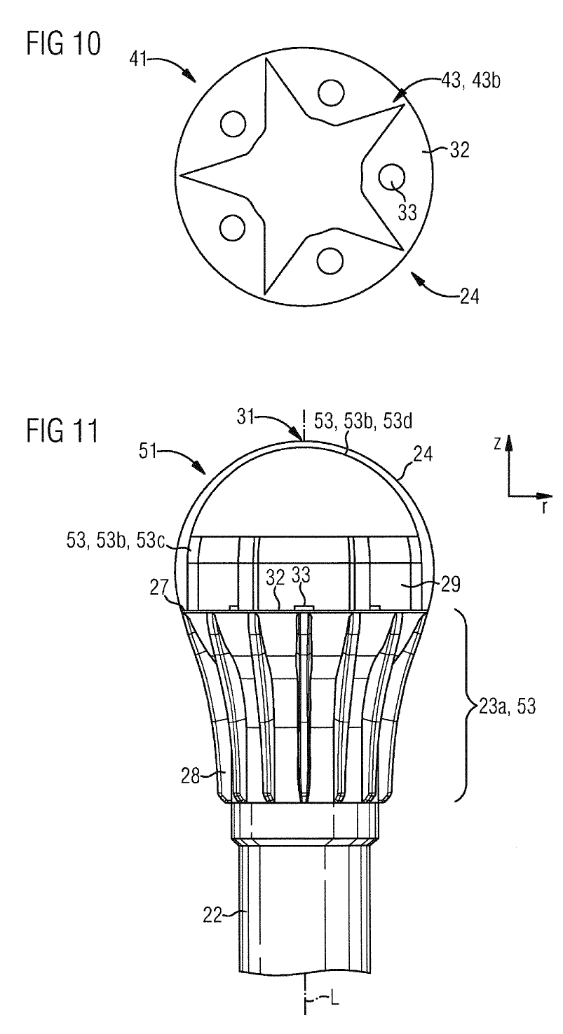

FIG. 10 shows a plan view of the LED retrofit lamp according to the third embodiment;

FIG. 11 shows a side view of an LED retrofit lamp according to a fourth embodiment;

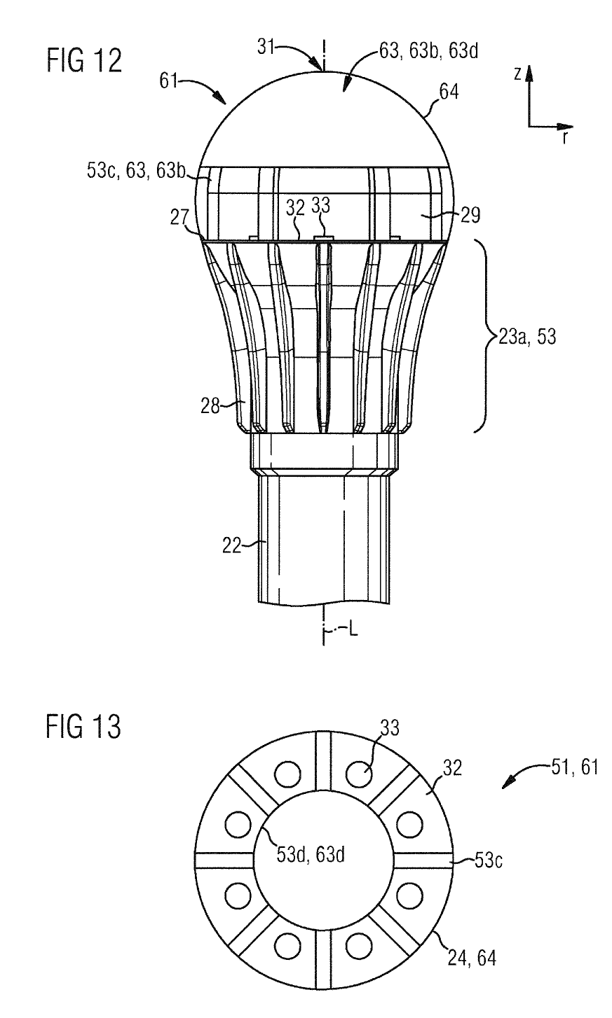

FIG. 12 shows a side view of an LED retrofit lamp according to a fifth embodiment;

FIG. 13 shows a plan view of the LED retrofit lamp according to the fourth and fifth embodiments;

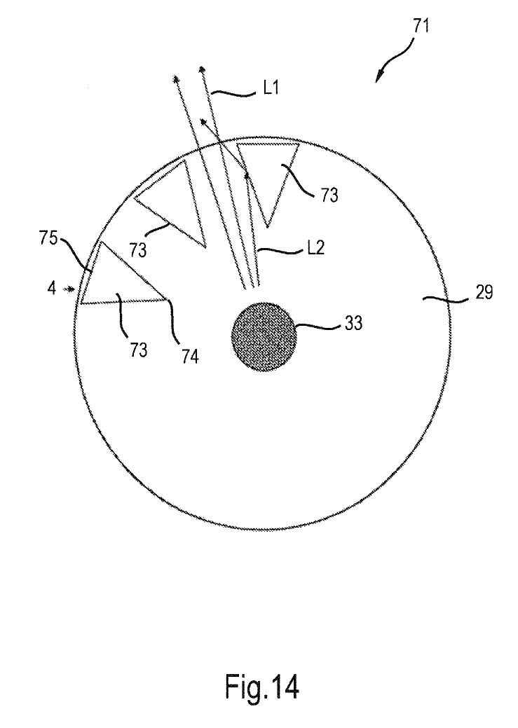

FIG. 14 shows a plan view sketch of a section through a bulb chamber of an LED retrofit lamp according to a sixth embodiment;

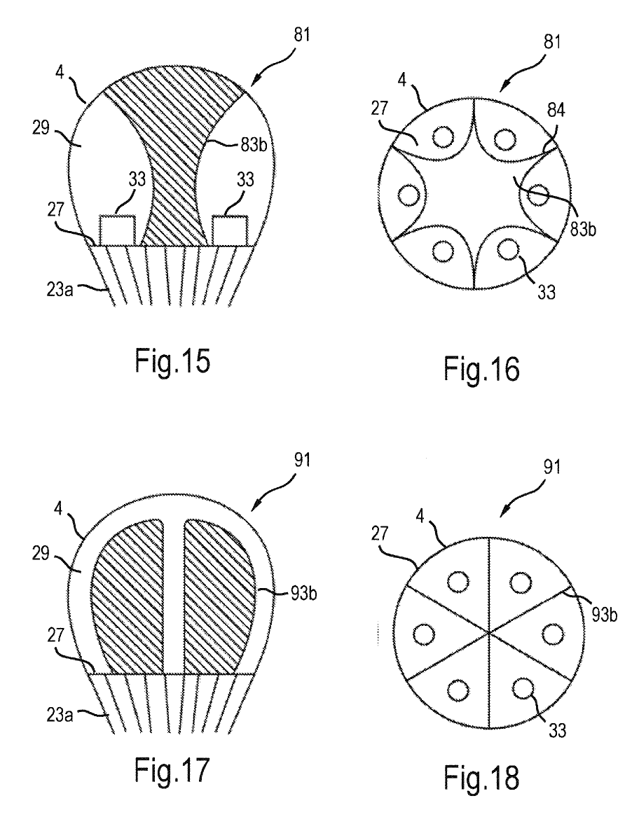

FIG. 15 shows a sectional side view sketch of an LED retrofit lamp according to a seventh embodiment;

FIG. 16 shows a sectional plan view sketch of the LED retrofit lamp according to the seventh embodiment;

FIG. 17 shows a sectional side view sketch of an LED retrofit lamp according to an eighth embodiment;

FIG. 18 shows a sectional plan view sketch of the LED retrofit lamp according to the eighth embodiment;

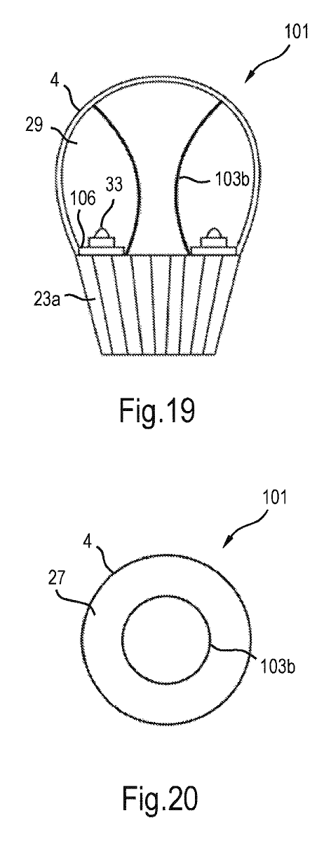

FIG. 19 shows a sectional side view sketch of an LED retrofit lamp according to a ninth embodiment;

FIG. 20 shows a sectional plan view sketch of the LED retrofit lamp according to the ninth embodiment;

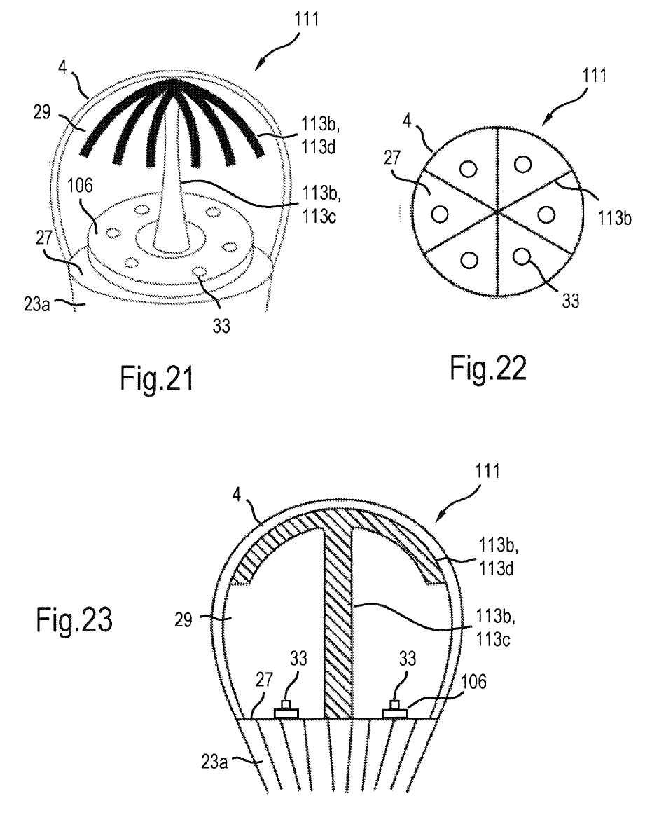

FIG. 21 shows a perspective view sketch of an LED retrofit lamp according to a tenth embodiment;

FIG. 22 shows a sectional plan view sketch of the LED retrofit lamp according to the tenth embodiment;

FIG. 23 shows a sectional side view sketch of the LED retrofit lamp according to the tenth embodiment;

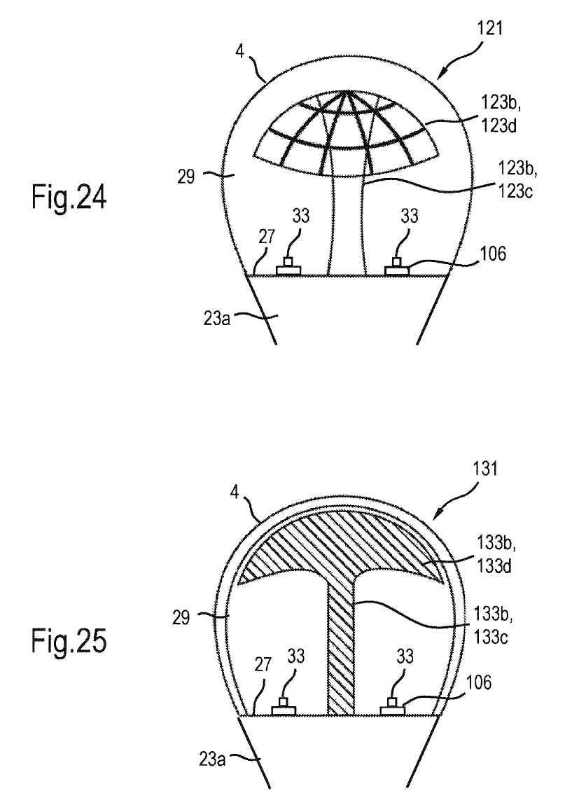

FIG. 24 shows a side view sketch of parts of an LED retrofit lamp according to an eleventh embodiment;

FIG. 25 shows a sectional side view sketch of an LED retrofit lamp according to a twelfth embodiment;

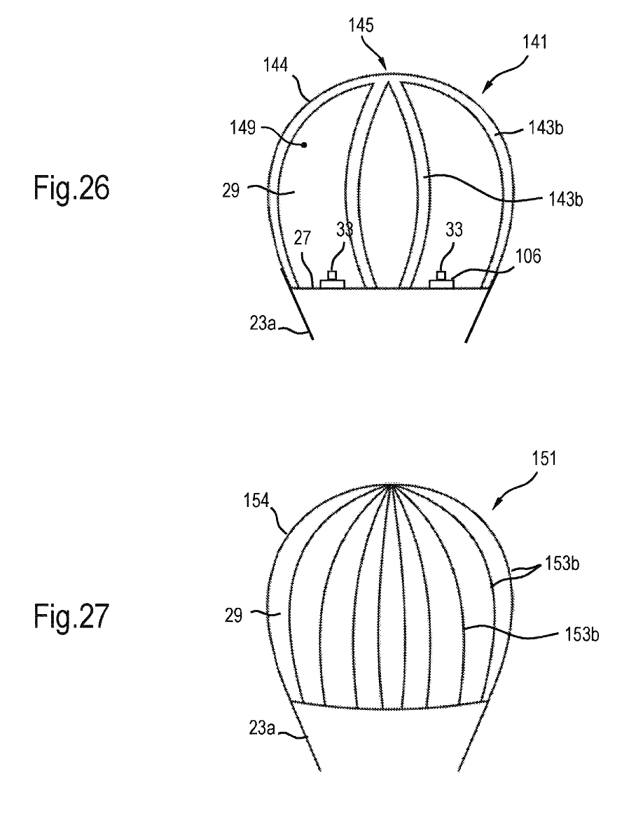

FIG. 26 shows a sectional side view sketch of an LED retrofit lamp according to a thirteenth embodiment;

FIG. 27 shows a sectional side view sketch of an LED retrofit lamp according to a fourteenth embodiment;

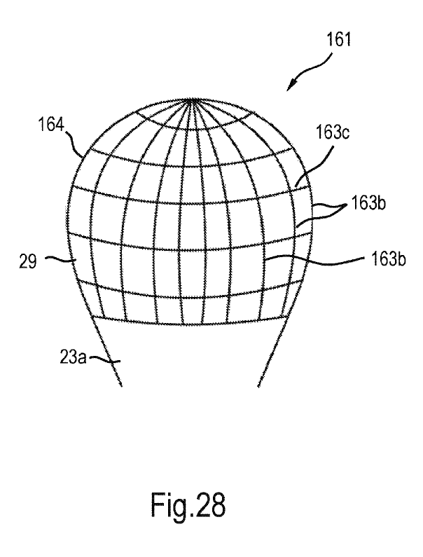

FIG. 28 shows a sectional side view sketch of an LED retrofit lamp according to a fifteenth embodiment;

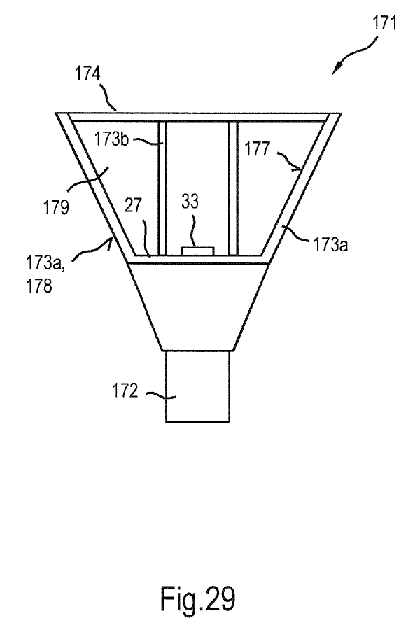

FIG. 29 shows a sectional side view sketch of an LED retrofit lamp according to a sixteenth embodiment.

FIGS. 1 to 28 show examples of an incandescent lamp-type retrofit LED lamp, whilst FIG. 29 shows a halogen reflector lamp-type retrofit LED lamp. However, the features disclosed with regard to the incandescent lamp-type retrofit LED lamp are also similarly usable for the halogen reflector lamp-type retrofit LED lamp, and vice versa.

FIG. 1 shows a side view and FIG. 2 shows a sectional side view of an LED retrofit lamp 1 according to a first embodiment. The LED retrofit lamp 1 includes a cap 2, a heat sink 3, an LED module 5 with at least one LED (not shown) and a light-transmissive (transparent or opaque) bulb 4. The LED retrofit lamp 1 can be supplied with current by means of the cap 2 which can be configured, for example, as an Edison cap or a bayonet cap. The current is fed via a driver circuit (not shown) to the at least one LED of the LED module 5. The driver circuit is accommodated in a driver cavity 6, which is provided in the heat sink 3. Thus, the heat generated by the driver circuit can also be conducted away via the heat sink 3.

The heat sink 3 is constructed in two parts, specifically with a heat sink base 3a which includes a contact surface, a support surface or mounting surface 7 for the LED module 5. The LED substrate is attached flat and with good thermal conduction (for example, by means of a thermally conductive adhesive, such as a heat transfer compound or a TIM adhesive tape) on the mounting surface 7, or more precisely, a support substrate (e.g. a circuit board and/or a submount) is attached with the rear side thereof flat on the mounting surface 7 of the heat sink base 3a, while a front side is equipped with at least one LED. In this context, ‘in front’/‘forward(ly)’ relates to an orientation in the z-direction (which also corresponds to the main radiating direction of the at least one LED) and ‘behind’/‘rearward(ly)’ corresponds to an orientation contrary to the z-direction.

The heat sink base 3a corresponds in form to a conventional heat sink, the cooling ribs 8 of which are distributed with rotational symmetry about the z-axis, which also corresponds to a longitudinal axis of the lighting device 1. The cooling ribs 8 are arranged behind the LED module 5 or the at least one light source.

The spherical cupola-shaped bulb 4 arches over the LED module 5 and therefore over the at least one LED, so that a hollow bulb chamber 9 is formed between the bulb 4 and the LED module 5 or the at least one LED. The bulb 4 also arches laterally over at least part of the cooling ribs 8, said cooling ribs 8 being partially exposed directly to the surroundings for a better cooling effect.

The second part of the heat sink 3 includes a heat sink structure 3b which, in this case, includes a ring of rotationally symmetrically arranged cooling ribs 10 which at the front adjoin the cooling ribs 8 of the heat sink base 3a. The cooling ribs 10 adjoin the bulb chamber 9 in that said ribs are accommodated within the bulb chamber 9, specifically at a distance of less than 1 mm from the bulb 4. The cooling ribs 10 have a circular segment-shaped contour directed toward the bulb 4 which follows the form of the bulb 4 while, at the inner side directed toward the LEDs, said contour is directed vertically upwardly or forwardly. The cooling ribs 10 have a height along the z-extent which approximately corresponds to ¾ of the maximum height hmax of the bulb chamber 9 between the LED module 5 or the at least one LED and an apex or tip 11 of the bulb chamber 9. The heat sink base 3a and the heat sink structure 3b can be, for example, glued together.

FIG. 3 shows a side view of the heat sink base 3a. An upper cover surface of a cylindrical central part 3c serves as the mounting surface 7, whereas the driver cavity 6 is accommodated in the central part 3c. The heat sink base 3a has a conventional structure.

FIG. 4 shows a side view of the overall heat sink 3 of the LED retrofit lamp 1 with the heat sink base 3a and the heat sink structure 3b. The additional cooling ribs 10 are arranged on the cooling ribs 8 and project forwardly (in the z-direction) therefrom, specifically initially laterally to the mounting surface 7 and then in front of the mounting surface 7. The thickness of the cooling ribs 8 and 10 is constant and equal.

FIG. 5 shows a view from obliquely above and FIG. 6 shows a side view of an LED retrofit lamp 21 according to the invention in a second embodiment.

The LED retrofit lamp 21 is configured, fundamentally similarly to the LED retrofit lamp 1 of the first embodiment, as an incandescent lamp-type retrofit LED lamp and, like said lamp type, includes a cap 22, a heat sink 23, an LED module 25 and a light-transmissive bulb 24.

The bulb 24 can be made of plastic, which enables particularly economical production and a simple design, or of glass, for example, Borofloat glass, which provides good ageing resistance and scratch resistance.

The LED module 25 has a circular circuit board 32 on which six forwardly radiating (in the z-direction) white LEDs 33 are mounted rotationally symmetrically about a longitudinal axis L of the LED retrofit lamp 21. In other words, the circuit board 32 is equipped with a plurality of LEDs 33 in an annular arrangement. Purely for simpler illustration, conductor bushings and cables, etc. leading to the diver arranged in a driver cavity of the heat sink 23 are not shown.

The heat sink 23 can be configured in one piece, but can be conceptually divided into two parts, specifically a heat sink base 23a and a heat sink structure 23b arranged essentially in front of the LEDs 33. The heat sink base 23a has a mounting surface 27 for mounting and fastening the LED module 25, and has cooling ribs 28, thereunder or therebehind, arranged radially and directed outwardly relative to the longitudinal axis L.

The heat sink structure 23b is also connected to the heat sink base 23a on the mounting surface 27, specifically in the radial direction (r-direction) outside the circuit board 32 of the LED module 25. The heat sink structure 23b has six cooling struts 30 extending vertically upwardly from the mounting surface 27, which curve inwardly and narrow with increasing height, in the direction of the tip 31 of the bulb chamber 29. The cooling struts 30 therefore essentially extend over the entire height of the bulb chamber 29. The free ends or tips of the cooling struts 30 do not touch one another. The cooling struts 30 are configured rotationally symmetrical relative to the longitudinal axis L for effective cooling. The cooling struts 30 also have a surface 34 which is flattened in the direction toward the bulb 24, and does not touch the bulb 24, but is spaced apart from the bulb with a small distance of approximately 1 mm or less.

The form of the cooling struts 30 and of the somewhat more than hemispherically configured bulb 24 are suitable for placing the bulb 24 on the heat sink 23, specifically on an outermost edge of the mounting surface 27 of the heat sink base 23a, as FIG. 7 shows in an enlarged section.

FIG. 8 shows the LED retrofit lamp 21 in a plan view. The cooling struts 30 are arranged at a maximum peripheral spacing from the LEDs 33, so that only a small proportion of the light radiated from the LEDs 33 is blocked by the cooling struts 30. In other words, the cooling struts 30 are not arranged above the LEDs 33, but laterally therefrom.

When the LED retrofit lamps 1 and 21 are operated, the LEDs 33 heat up due to heat loss therefrom. This heat is emitted, to an overwhelming extent, via the circuit board 32 to the mounting surface 7 or 27 of the heat sink 3 or 23 and heats the bulb chamber 9 or 29 to a small extent. Due to the spread of heat in the heat sink 3, 23, part of the heat is conducted to the cooling ribs 8, 28 and, from there, is radiated to the surroundings. However, the surface area of the cooling ribs 8, 28 is restricted due to a form factor for suitability thereof as an LED retrofit lamp.

For effective cooling and heat removal, the heat is therefore also conducted away to the heat sink structure 23b (cooling ribs 10, cooling struts 30) and heats said structure. Heat is therefore conducted more strongly into the bulb chamber 9, 29 and therefrom into the bulb 4, 24. Due to the extending of the cooling structure 10, 30 over more than half the height of the bulb chamber 9, 29, in particular a front region which is otherwise relatively cool, is heated. In this way, the bulb 4, 24 is heated more strongly, particularly in the front region thereof and therefore emits more heat than without the cooling structure 10, 30.

FIG. 9 shows a side view and FIG. 10 shows a plan view of an LED retrofit lamp 41 according to a third embodiment. The LED retrofit lamp 41 is similar to the LED retrofit lamp 21 according to the second embodiment, except that the heat sink structure 43b of the heat sink 43 is differently designed.

The heat sink part 43b is configured such that six cooling struts 43c arranged rotationally symmetrically to the longitudinal axis extend, similarly to the cooling struts 30, initially perpendicularly from the mounting surface of the heat sink 43 forwardly or upwardly. In contrast to the second embodiment, the cooling struts 43c run together in a front or upper half of the bulb 24, gradually forming a cupola shape and therefore form a closed cupola-shaped heat sink structure 43d. An overwhelming proportion of the surface of the heat sink structure 43b is therefore arranged in a front part or a front half of the bulb chamber 29. The cupola-shaped heat sink structure 43d does not cover the LEDs 33, but blocks or reflects (diffusely or specularly) a larger proportion of the light than in the retrofit lamp 21 according to the second embodiment. Therefore, a distribution of light which, due to the use of LEDs 33 is more strongly directed forwardly (in the direction of the z-axis) than in a conventional incandescent lamp, can be approximated more closely to the light distribution of a conventional incandescent lamp. In addition, a front region of the bulb chamber 29 and of the bulb 24 is more strongly heated than in the second embodiment, so that heat can be conducted away more effectively. Furthermore, the heat sink structure 43b is mechanically more stable.

FIG. 11 shows a side view of an LED retrofit lamp according to a fourth embodiment. The LED retrofit lamp 51 is similar to the LED retrofit lamp 41 according to the third embodiment, except that the heat sink structure 53b of the heat sink 53 situated essentially in front of the LEDs 33 is differently designed. The cooling struts 53c do not give way gradually or continuously to one another, but give way directly to a spherical cupola-shaped or shell-shaped cap 53d, which is arranged in a front region of the bulb chamber 29. Here also the front region of the bulb chamber 29 and of the bulb 24 is more severely heated than in the second embodiment, so that heat can be more effectively conducted away. The heat sink structure 53b is also mechanically more stable. The heat sink structure 53b can be spaced apart from the bulb 24 or at least partially adjoin or contact the bulb 24 directly. Direct contact improves heat conduction from the heat sink structure 53b into the bulb 24.

FIG. 12 shows a side view of an LED retrofit lamp 61 according to a fifth embodiment similar to the LED retrofit lamp 51 according to the fourth embodiment. In contrast to the fourth embodiment, the shell-shaped cap 63d of the heat sink part 63b of the heat sink 63 arranged in front of the LEDs 33 replaces part of the light-transmissive material of the bulb 64 and therefore represents part of the bulb. The cap 63d is therefore exposed at the outer side thereof to the surroundings, which enhances heat dissipation to the surroundings. At the inner side, the cap 63d delimits the bulb chamber 29 and therefore, apart from the heat fed through the cooling struts 63c, can also conduct away the heat from the bulb chamber 29 directly and over a large area.

FIG. 13 shows a plan view of an exemplary embodiment of the LED retrofit lamps 51, 61 according to the fourth and fifth embodiments. Here also, the LEDs 33 are not directly covered by the heat sink part 53b or 63b, particularly the cap 53d or 63d.

FIG. 14 shows a plan view sketch of a section through a bulb chamber 9 of an LED retrofit lamp 71 according to a sixth embodiment. Cooling struts 73, of which only three are shown here, are introduced rotationally symmetrically into the bulb 4. The cooling struts 73 laterally surround a single, centrally arranged LED 33. The cross-sectional form of the cooling struts 73 is triangular, a sharp edge 74 of each cooling strut 73 being directed toward the centrally arranged LED 33 and a planar surface 75 facing away from the edge 74 being arranged opposing the bulb 4. The cooling struts 73 are mounted spaced apart from the bulb 4. Due to the broad surface 75, effective heat transmission from each cooling strut 73 to the bulb 4 takes place.

A surface of the cooling struts 73 is configured (diffusely or specularly) reflectively so that the light radiated laterally from the LED 33 is further homogenized since some light rays L1 run straight between the cooling struts 73 and other light rays L2 are deflected by the cooling struts 73.

Naturally, other cross-sectional forms (oval, round, rectangular or polygonal, etc.) and cross-sectional sizes, which may vary over the height, can be used.

FIG. 15 shows a sectional side view and FIG. 16 shows a sectional plan view, both in sketch form, of an LED retrofit lamp 81 according to a seventh embodiment. The heat sink 83 here has a heat sink structure which stands upright from the mounting surface 27 in the form of a centrally arranged central column 83b. The lower contact surface or the lower region of the central column 83b is laterally surrounded by an annular group of LEDs 33. Toward the front, i.e. with increasing height, the central column 83b initially narrows and then expands again in a star shape at the front region. The front region of the central column 83b extends to the tip of the bulb chamber 29, so that the central column 83b covers the whole height of the bulb chamber 29. The central column 83b does not cover the LEDs 33, but rather projections 84 or ‘points’ of the star-shaped expansion spaced apart in the peripheral direction extend laterally over and beyond the LEDs 33. The use of the central column 83b has the advantage that (on use of an annular LED circuit board) said column can make contact with a large part of the mounting surface 27 or the circuit board and therefore achieves very good thermal conduction from the heat sink base 23a. For effective heat conduction, the central column 83b is made from a solid material, for example, a metal. The large surface in the front region of the bulb chamber 29 and possibly contacting of the bulb 4 also achieves good heat removal to the outside. The waisted form of the central column 83b supports a (diffuse or specular) light reflection for homogenizing the light radiation in a height direction.

FIG. 17 shows a sectional side view and FIG. 18 shows a sectional plan view, both in sketch form, of an LED retrofit lamp 91 according to an eighth embodiment. The LED retrofit lamp 91 is equipped with a heat sink structure arranged in front of a plurality of LEDs 33, which includes plate-shaped cooling ribs 93b which stand upright between the LEDs 33 in the bulb chamber 29 and extend over the whole height of the bulb chamber 29. The cooling ribs 93b are oriented, in plan view, toward a center of the bulb chamber 29 and therefore delimit adjacent LEDs 33 from one another. Homogenization of the light radiated from the LEDs 33 is achieved by a reflecting surface of the cooling ribs 93b. The cooling ribs 93b can be configured specularly or (by scattering) diffusely reflectively. The cooling ribs 93b can also have a large area of contact with the mounting surface 27 or the circuit board. In that the cooling ribs 93b expand forwardly (in the z-direction), heat conduction into the front region of the bulb 4 is promoted.

FIG. 19 shows a sectional side view and FIG. 20 shows a sectional plan view, both in sketch form, of an LED retrofit lamp 101 according to a ninth embodiment similar to the seventh embodiment. In contrast to the seventh embodiment, the central column 103b covers the main radiating direction of the LEDs 33, which are arranged on an annular circuit board 106 round the central column 103b. In other words, the central column 103b covers the LEDs 33, such that the forward radiating direction is further suppressed and the light radiated from the LEDs 33 is radiated more strongly laterally. This can be preferable, for example, in a side-emitting application, for example, for ceiling lamps, hallway lights or bathroom mirror lights. For this purpose, a surface of the central column 103b adjoining the bulb chamber 29 can be configured specularly or diffusely reflectively. As with the other embodiments, the reflection can be brought about, for example, by means of a suitable coating.

FIG. 21 shows, in a perspective view and FIG. 22 shows in a sectional plan view, and FIG. 23 shows in a sectional side view, each in sketch form, an LED retrofit lamp 111 according to a tenth embodiment. Here too the heat sink has a heat sink structure which stands in the form of a centrally arranged central column 113b from the mounting surface 27. The central column 113b has a waisted ‘stem’ 113c leading to an upper tip of the bulb chamber 29 for good heat removal from the mounting surface 27. The stem 113c is surrounded by an annular circuit board equipped on the front side with the LEDs 33. At the front end, rotationally symmetrically arranged strips 113d emerge laterally from the stem 113c. Said strips 113d do no cover the LEDs 33. By means of the ‘palm-shaped’ central column 113b shown, a proportion of the light falling forwardly through the strips 113d can easily be adjusted, for example, by a width and/or a length of the strips 113d. Consequently, the intensity of light radiated forwardly can also be adjusted by simple means. The strips 113d can be reflective, at least in the downward direction or adjacent to the bulb chamber 29, in order to increase a light yield and a proportion of the light directed laterally and downwardly.

FIG. 24 shows a sectional side view sketch of parts of an LED retrofit lamp 121 according to an eleventh embodiment, which represents a variant of the tenth embodiment in that, in place of the individual strips, an arched grid-shaped or umbrella-rib-like cooling structure 123d emerges from the tip of the stem 123c. This increases both the forward shading and the mechanical stability. Here also, due to the surface of the cooling structure 123b being arranged overwhelmingly in a front region of the bulb chamber 29 and here also of the bulb 4, good heat conduction into and then out of said front region is achieved.

FIG. 25 shows a side view sketch of parts of an LED retrofit lamp 131 according to a twelfth embodiment. In contrast to the tenth embodiment, an arched, hood-like front cap 133d extends from the tip of the stem 133c of the cooling structure 133b. This ‘anchor-shaped’ configuration increases the shading forwardly and further enhances mechanical stability.

FIG. 26 shows a sectional side view sketch of an LED retrofit lamp 141 according to a thirteenth embodiment. In this case, cooling struts 143b arranged on the mounting surface 27 extend upwardly as annular segments and unite at the tip 145 of the bulb 144. The cooling struts 143b of the heat sink structure alternate with light-transmissive regions 149. For this purpose, the material of the light-transmissive regions 149 has been introduced into the intermediate spaces between the cooling struts 143b, for example injection molded in the case of a light-transmissive plastic. Due to the direct exposure of the cooling struts 143b, in particular, to the surroundings, this embodiment results in particularly good heat output. The cooling struts 143b can be made, for example, of metal or an alloy, or a carbon material such as graphite, etc.

Alternatively, the cooling struts 143b can be completely or partially surrounded by the light-transmissive material, for example injection molded. An embodiment of this type can be simpler from the manufacturing standpoint and can result in a more pleasing appearance.

FIG. 27 shows a sectional side sketch view of an LED retrofit lamp 151 according to a fourteenth embodiment. In place of the cooling struts of relatively thick cross-section, thin cooling wires or cooling threads 153b are used here as the heat sink structure. The cooling threads 153b extend from a mounting surface of the heat sink base to the tip of the bulb 154. The cooling threads 153b can be cast, particularly within the light-transmissive material of the bulb 154. For example, silver threads, graphite threads, copper wires or threads, etc., can be used as the cooling threads 153b. Although a single cooling thread 153b can conduct less heat than a single cooling strut, the cooling threads 153b can be used in larger numbers. The cooling threads can result in more even shading.

FIG. 28 shows a sectional side sketch view of an LED retrofit lamp 161 according to a fifteenth embodiment similar to the fourteenth embodiment using cooling threads 163b as the heat sink structure of the heat sink. In addition to the cooling threads 163b extending from a mounting surface of the heat sink or from a (massive) heat sink base part to the tip of the bulb 164, cooling threads 163c extending in the peripheral direction are provided, which further improve the heat removal. The cooling threads 163c are in thermal contact with the cooling threads 163b and can be produced, for example, integrally therewith as a net-like structure which can, in particular, be cast into the light-transmissive material of the bulb 164.

FIG. 29 shows a sectional side sketch view of an LED retrofit lamp 171 according to a sixteenth embodiment. The LED retrofit lamp 171 is configured as a retrofit lamp for a halogen spot light.

The LED retrofit lamp 171 includes a heat sink base 173a which is configured essentially funnel-shaped and gives way rearwardly to a cap 172, for example, a bayonet cap. An upper aperture of the funnel is covered by a pane-shaped light-transmissive cover 174, so that the heat sink base 173a and the cover 174 form a hollow chamber 179. Arranged on the cap 172 serving as the base of the funnel of the heat sink base 173a is at least one LED 33 which has a vertically upward main beam direction directed through the cover 174. The hollow chamber 179 is therefore essentially also formed between the at least one LED and the cover 174.

Whereas, conventionally, the heat sink base 173a has cooling ribs 178 at the outer side thereof for conducting away the heat generated by the at least one LED 33, the inner side 177 of the funnel is mostly smooth and therefore has no heat sink structures.

In the embodiment shown, a heat sink structure in the form of cooling struts 173b standing upright is introduced into the hollow chamber 179. The cooling struts 173b stand on the base of the funnel or the cap 172 and extend over the whole height of the hollow chamber 179 until said struts contact the cover 174. In this way, a further ‘heat channel’ is created from the cap 172 to the cover 174, which promotes heat removal from the at least one LED 33. However, other heat sink structures can also be used, for example, similarly to the exemplary embodiments shown in FIGS. 1 to 28.

Naturally, the present invention is not restricted to the exemplary embodiments shown.

All the heat sink structures shown and other such structures arranged in front of the at least one light source can be spaced apart from the bulb, partially replace said bulb and/or be surrounded by the light-transmissive material.

In general, features of the embodiments can be combined and/or replaced among one another. Thus, elements of the incandescent lamp-type retrofit LED lamp shown in FIGS. 1 to 28 can also be used for the halogen reflector lamp-type retrofit LED lamp shown in FIG. 29, or for other lamp types, such as linear lamps, fluorescent tubes, etc.

### LIST OF REFERENCE CHARACTERS

1 LED retrofit lamp
2 cap
3 heat sink
3a heat sink base
3b heat sink structure
3c central part
4 bulb
5 LED module
6 driver cavity
7 mounting surface
8 cooling ribs
9 bulb chamber
10 cooling rib
11 tip of bulb chamber
21 LED retrofit lamp
22 cap
23 heat sink
23a heat sink base
23b heat sink structure
24 bulb
25 LED module
27 mounting surface
28 cooling rib
29 bulb chamber
30 cooling strut
31 tip of bulb chamber
32 circuit board
33 light-emitting diode, LED
34 surface of cooling strut
41 LED retrofit lamp
43 heat sink
43b heat sink structure
43c cooling strut
43d cupola-shaped heat sink structure
51 LED retrofit lamp
53 heat sink
53b heat sink structure
53c cooling strut
53d bowl-shaped front cap
61 LED retrofit lamp
63 heat sink
63b heat sink part
63c cooling strut
63d shell-shaped front cap
64 bulb
71 LED retrofit lamp
73 cooling strut
74 sharp edge of the cooling strut
75 flat surface of the cooling strut
81 LED retrofit lamp
83 heat sink
83b central column
84 tip
91 LED retrofit lamp
93b cooling rib
101 LED retrofit lamp
103b central column
106 annular circuit board
111 LED retrofit lamp
113b central column
113c stem
113d strip
121 LED retrofit lamp
123b heat sink structure
123c stem
123d umbrella-rib-like cooling structure
131 LED retrofit lamp
133b heat sink structure
133c stem
133d cap
141 LED retrofit lamp
143b cooling strut
144 bulb
145 tip of bulb
149 light-transmissive region of bulb
151 LED retrofit lamp
153b cooling thread
154 bulb
161 LED retrofit lamp
163b cooling thread
163c cooling thread
164 bulb
171 LED retrofit lamp
172 cap
173a heat sink base
173b cooling strut
174 cover
177 inner side of funnel
178 outer side
179 hollow chamber
hmax maximum height of hollow chamber
L longitudinal axis
L1 light ray
L2 light ray
z z-axis

1. A lighting device, comprising
at least one partially light-transmissive cover which covers at least one light source, so that a hollow chamber is provided between the at least one light source and the cover, and
at least one heat sink structure, which is at least one of at least partially arranged in the hollow chamber and is set at least partially into the cover.

2. The lighting device as claimed in claim 1,
wherein the cover is a bulb and the hollow chamber is a bulb chamber.

3. The lighting device as claimed in claim 1,
wherein the heat sink structure is connected to a heat sink base.

4. The lighting device as claimed in claim 1,
wherein the heat sink structure is arranged at least partially within the hollow chamber.

5. The lighting device as claimed in claim 1,
wherein the heat sink structure is at least partially surrounded by a light-transmissive material of the cover.

6. The lighting device as claimed in claim 5,
wherein the heat sink structure comprises at least one of at least one wire and thread.

7. The lighting device as claimed in claim 1,
wherein the heat sink structure projects at least as far as a center of the hollow chamber.

8. The lighting device as claimed in claim 2,
wherein the heat sink structure replaces part of the bulb.

9. The lighting device as claimed in claim 1,
wherein the heat sink structure has cooling struts arranged with rotational symmetry.

10. The lighting device as claimed in claim 9,
wherein the cooling struts at least partially have a cross-sectional form which widens toward the cover.

11. The lighting device as claimed in claim 2,
wherein a largest part of the surface of the heat sink structure is arranged at a front half of the bulb.

12. The lighting device as claimed in claim 1,
wherein at least part of the heat sink structure comprises an optically active surface.

13. The lighting device as claimed in claim 2,
wherein the heat sink structure has a central column extending forwardly from the mounting region as far as the bulb.

14. The lighting device as claimed in claim 13,
wherein the central column extends in a forward region at least partially laterally further than a group of at least two light sources surrounding the central column.

15. The lighting device as claimed in claim 1,
wherein the lighting device is a retrofit lamp.

16. The lighting device as claimed in claim 1,
wherein the at least one light source comprises a light-emitting diode.

17. The lighting device as claimed in claim 3,
wherein the heat sink structure is connected to a mounting surface of the heat sink base for the at least one light source.

18. The lighting device as claimed in claim 4,
wherein the heat sink structure is arranged completely within the hollow chamber.

19. The lighting device as claimed in claim 5,
wherein the cover comprises cast.

20. The lighting device as claimed in claim 15,
wherein the retrofit lamp comprises an incandescent lamp-type retrofit lamp.
